(19) United States
(12) Patent Application Publication
(10) Pub. No.: US 2014/0138105 A1
(43) Pub. Date: May 22, 2014

(54) FIRE SUPPRESSION FLUID CONTAINING A CARBOXYLATE SALT

(71) Applicants: Matthew R. Kuwatch, Green, OH (US); Kenneth C. Lilje, Midland, MI (US); Michael G. Foster, Midland, MI (US); Andrew M. Olah, Spencer, OH (US)

(72) Inventors: Matthew R. Kuwatch, Green, OH (US); Kenneth C. Lilje, Midland, MI (US); Michael G. Foster, Midland, MI (US); Andrew M. Olah, Spencer, OH (US)

(73) Assignee: LUBRIZOL ADVANCED MATERIALS, INC., Cleveland, OH (US)

(21) Appl. No.: 14/113,452

(22) PCT Filed: May 9, 2012
(86) PCT No.: PCT/US2012/036989

§ 371 Date: Dec. 6, 2013

Related U.S. Application Data
(60) Provisional application No. 61/483,953, filed on May 9, 2011.

(51) Int. Cl. A62D 1/00

(52) U.S. Cl. CPC A62D 1/0042
USPC 169/46; 169/5; 252/2

(57) ABSTRACT

An aqueous fire sprinkler fluid containing low carbon number carboxylate salts for freezing point depression is described. The salts may be used in conjunction with glycols. The salts decrease the combustibility of the glycol containing fluids and give lower viscosity than higher glycol fluids, both benefitting fire sprinkler systems. These salt solutions are friendly to metal and CPVC pipes and are thus useful for fire sprinkler systems by not causing environmental stress cracking of the CPVC components and not being corrosive to the metal parts.

### FIELD OF INVENTION

Fluids in a fire sprinkler system have to remain fluid at low temperatures such as below 0° C. and preferably below −40° C. They also need to protect the fire sprinkler system over long term static conditions. As such, they need to be compatible with and non-corrosive to the construction materials in a fire sprinkler system as well as providing the primary function to be able to suppress or extinguish fires. The fluids, disclosed herein, include a low carbon number carboxylate salt of sodium or potassium which acts as an electrolyte to reduce the freezing point of the water used in the solution often in conjunction with a glycol. The selected salt(s) impart other desired properties disclosed herein as well.

### BACKGROUND OF INVENTION

Ethylene glycol water solutions are commonly used for fire sprinkler fluids due to the low corrosivity of the glycol and the low fire hazard associated with it. The glycol is used to depress the freezing point of the fluids. A problem with these solutions is their potential toxicity both to the environment and to food products or animals, and the possible contamination of potable water systems to which the fire sprinkler system may be connected. For lower toxicity, some systems use or have converted to propylene glycol as an alternative to ethylene glycol. Due to the higher carbon content, the aqueous solutions of propylene glycol need to be carefully balanced to avoid fire or explosion hazards associated with a fine mist of organic carbon-containing water exposed to a fire or ignition source. Such fluids need to be non-corrosive to iron pipe particularly, but also with non-ferrous metals. In addition, such sprinkler fluids may be used with chlorinated polyvinylchloride (CPVC) pipe such as BlazeMaster®. Thus, compatibility with CPVC is also required. High concentrations of propylene glycol when exposed to CPVC pipe may contribute to environmental stress cracking. To mitigate this concern, glycerin (aka. glycerol) may be preferred.

One problem with glycerin, and to a lesser extent with any glycol, is too high of viscosity of the aqueous fluids at low temperature. Low viscosity of the aqueous fluids at low temperature is optimal for fire sprinklers. In summary, the ideal fire sprinkler fluid maintains good fluidity at low temperature, is non-toxic, non-combustible, non-corrosive to metals and is compatible with CPVC.

U.S. Pat. No. 2,266,189 reveals antifreeze compositions which use potassium acetate or potassium formate solutions, among others, as replacements for glycol water solutions as heat transfer fluids. It further discloses the use of certain corrosion inhibitors and mentions the low viscosity of the salt solutions compared to glycol or glycerol solutions. U.S. Pat. No. 3,252,902; U.S. Pat. No. 4,756,839; U.S. Pat. No. 5,820,776; U.S. Pat. No. 5,945,025 and EP 0 376 963 B1 show carboxylate salts in fire extinguishing compositions, the last four in combination with carbonate or bicarbonate. U.S. Pat. No. 6,367,560 shows a potassium lactate solution in a sprinkler system for cold environments. U.S. Pat. No. 6,059,966 discloses a low-viscosity, aqueous coolant brine based on inhibited alkali metal acetates and/or formates having improved corrosion protection, wherein the coolant brines contain 0.2 to 5% by weight of alkali metal sulfites or pyrosulfites. U.S. Pat. No. 6,659,123 discloses maintaining a fire hydrant in cold weather using potassium formate, preferably at least 10% by weight in water. U.S. Pat. No. 6,983,614 assigned to Lubrizol Corp. taught potassium formate heat transfer fluids. Japan patent application publication JP2003135620 discloses potassium formate in various concentrations in water as antifreeze for fire sprinkler systems as a replacement for ethylene glycol. Small amounts of glycol are allowed for dissolving corrosion inhibitors, but the emphasis is on eliminating glycols in general to reduce the C.O.D and B.O.D. and the load to the environment. None of the prior art references mention the protection of CPVC with selected carboxylate salts or the selection of propylene glycol or glycerol with selected carboxylate salts to mitigate of the combustibility of aqueous solutions therefrom.

It would be desirable to identify a fire suppression fluid with lower toxicity than ethylene glycol solutions, having good low temperature fluidity and minimal tendency toward metal corrosion or degradation of CPVC and/or the fluids containing non-toxic propylene glycol or glycerol with suppressed or inhibited combustibility and improved fluidity through the selective presence of certain carboxylate salts.

### SUMMARY OF INVENTION

A freezing point depressed aqueous fluid for a fire sprinkler system comprising in addition to water:

a) at least one low carbon number carboxylate salt at 10-50% by weight;

b) at least one glycol at 0-60% by weight; and

c) at least one corrosion inhibitor at 0.001-10% by weight.

In one embodiment, the low carbon number carboxylate salt is potassium formate, sodium formate or mixtures thereof. In some embodiments, there may be a glycol, such as propylene glycol or glycerol, present and desirably not ethylene glycol.

The invention also encompasses a fire sprinkler system containing CPVC and a fluid described above, providing protection from freezing down to −10° C. or −40° C. or below, as well as protection from metal corrosion and CPVC degradation, particularly environmental stress cracking (ESC) of CPVC constructed pipes and fittings. At the same time, the fluid is desirably low in toxicity and has good fluidity at low temperatures like less than −10° C. or even −40° C.

By the terminology of a fire sprinkler system containing CPVC, we mean a system comprising a pressurization method, CPVC pipes or conduits designed to contain and carry a fire extinguishing media to the sprinklers, and sprinkler heads for extinguishing fires. The term CPVC pipe or conduit is used herein to refer to a single component pipe or a composite pipe which comprises a major amount of CPVC and meets CTS (copper tube size) or IPS (iron pipe size) requirements, whether it is tubing or pipe. The term “conduit” is used herein to refer to the extruded inner and outer tubular layers of CPVC polymer, and to the tubular metal sandwiched between them; adhesive used to coat the inner and outer surfaces of the metal conduit are referred to as inner and outer layers of adhesive. CPVC (chlorinated poly(vinyl chloride)) is the predominate polymer used in the pipe or composite pipe disclosed herein. CPVC compositions for pipes and conduits contain moderate amounts of other polymer materials, such as impact modifiers, processing aids and lubricants. The CPVC compositions of the conduits desirably have PVC or CPVC as greater than 50, preferably greater than 70 and more preferably greater than 80 weight percent of the composition.

The CPVC piping or conduit system may include various joints, fittings, junctions, and the like. Portions of CPVC piping can be joined together via a bonding agent (such as solvent cement), a chemical bond, and/or a mechanical linkage.

CPVC, for use herein, is preferably prepared by the post-chlorination of polymerized vinyl chloride such as suspension or mass polymerized PVC. Suspension polymerization techniques are well established in the art and set forth in the Encyclopedia of PVC, pp. 76-85, published by Marcel Decker, Inc. (1976) and need not be discussed in great detail here.

CPVC is obtained by chlorinating homopolymers or copolymers containing more than 50 wt. % repeat units from vinyl chloride and less than 50 wt. % by weight of one or more copolymerizable comonomers. Suitable comonomers for vinyl chloride include but are not limited to acrylic and methacrylic acids; esters of acrylic and methacrylic acid, wherein the alkyl group of the ester has from 1 to 12 carbon atoms. Chlorination of PVC can be carried out in any conventional manner as known to the art and to the literature to obtain a chlorinated base polymer having higher than 57 percent by weight chlorine up to about 74 percent by weight based upon the total weight of the polymer, however, in the practice of the invention, the use of a major amount of CPVC having a chlorine content of greater than 65% and up to 74% is preferred, and more preferably from 67% to about 71% chlorine.

The CPVC piping or conduit may additionally meet fire endurance requirements set forth by the IMO (International Maritime Organization). The fire endurance of a piping system is the capability to maintain its strength and integrity (e.g., capable of performing its intended function) for some predetermined period of time while exposed to fire that reflects anticipated conditions. The CPVC piping or conduit can conform to at least one of three different levels of fire endurance. For instance, the CPVC piping or conduit can conform to a highest level of fire endurance, which ensures the integrity of the CPVC piping or conduit during a full-scale hydrocarbon fire and/or it may continue to have sufficient integrity to perform its function after a fire has been extinguished.

In one embodiment, the fluid in the CPVC system comprises potassium formate in the range of 5% wt. to 40% wt. of the fluid or higher. In other embodiments the fluid in the CPVC system may also contain glycerol or propylene glycol in an amount from 5% to 40% wt. or even 60%, with the proviso that at least 20% wt. of the fluid is water. The salts of the low carbon number carboxylic acid, such as potassium formate, allow for lower viscosity at low temperature, even when glycols are present as co-freeze point depressants. These carboxylate salts have surprisingly been found to suppress the combustibility of any glycols that may be present in the fluid. They are also believed to mitigate degradation and prevent ESC of CPVC by certain glycols, such as propylene glycol.

### DETAILED DESCRIPTION OF THE INVENTION

The freezing point depressed aqueous fluid for a fire sprinkler system may also be referred to as a fire sprinkler fluid or a fire suppression fluid. A sprinkler system containing such a fluid that may also contain piping or components made of CPVC will also be described. The fluids are designed to be compatible with CPVC, have low corrosivity to metals, particularly iron and steel, but also to nonferrous metals. At the same time, the fluids do not freeze at low temperature and have acceptably low viscosity, a low temperature, such as less than −10° C. and preferably remain fluid to less than −40° C. The compositions of the fluids are aqueous solutions of one or more low carbon number carboxylic acid salts. The low carbon number carboxylate salt will typically be a potassium and/or sodium salt. Other metal ions may also be present such as lithium, magnesium or calcium. Desirably, the salt is primarily a potassium salt. The low carbon number carboxylate may be derived from a low carbon number carboxylic acid including formic acid, acetic acid, propionic acid, glycolic acid, lactic acid or mixtures thereof. Low carbon number carboxylic acids have 3 or less carbon atoms in their structure. There may also be present small amounts of salts of higher carbon number carboxylic acids such as 2-ethylhexanoic acid. Higher carbon number materials may improve the corrosion resistance of the fluid. The salts may also include salts of dicarboxylic acids or even tricarboxylic acids where the average number of carbons per carboxylic acid group is 3 or less. Such acids include oxalic acid, succinic acid, malic acid, tartaric acid, citric acid, glutaric acid, adipic acid and saccharic acid. These acids or their salts may additionally function as corrosion inhibitors. They may be used in significant amounts as long as they remain soluble and compatible with the aqueous solution and its desired properties. Small amounts of even higher dicarboxylic acids or their salts, such as sebacic acid or pelargonic acid, may be present and serve as corrosion inhibitors. To further enhance the fire suppression capability of the solutions known fire extinguishing carbonates or bicarbonate salts, such as potassium carbonate, potassium or sodium bicarbonate may optionally be present. The carbonates or bicarbonates may also enhance other properties such as corrosion protection of metals and mitigation of ESC of CPVC.

The low carbon number carboxylate salt based freeze protection fluid, described in this invention, have the ability to be used in a water based, hydraulically calculated fire protection (sprinkler) system. In some embodiments, the fluid additionally has one or more of the following desired properties:
1. Non-combustible when tested in a full scale, US 1626 based, room fire test for spray ignition using sprinklers;
2. Freezing point protection down to and below −40° F. (−40° C.) as per NFPA (National Fire Prevention Organization) 13.7.6.2;
3. Good low temperature viscosity characteristics, i.e., low viscosity at low temperatures;
4. No flash point as determined by ASTM D 56 (D 92, D93 . . . )
5. Inhibits the growth of microbiologically influenced corrosion (MIC) in metal based piping systems;
6. Does not induce environmental stress cracking (ESC) in CPVC materials as determined by ASTM F 2331;
7. Is not considered toxic or a contaminant to potable water systems.

Desirably, the solution is from about 2 to about 70 weight percent of a low carbon number carboxylate salt of potassium and/or sodium. More desirably, it is a formate salt and is from about 5 or 15 to about 65 weight percent and preferably from about 10 to about 60 weight percent of the fire sprinkler fluid. Desirably, the formate salt is at least 50 mole percent of the total salts in the solution and more desirably at least 75 or 80 mole percent. Desirably, the other low carbon number carboxylate salts like acetate are less than 10 mole % of the total salts.

In one embodiment, the low carbon number carboxylate is a formate and the resultant freeze protection fluid for utilization in water based, hydraulically calculated fire protection (sprinkler) systems further includes a biocide. In other embodiments, the fluid further contains a glycol of the following:
i) propylene glycol up to 50% by weight
ii) glycerin up to 50% by weight
iii) ethylene glycol up to 50% by weight
iv) diethylene glycol up to 50% by weight
v) any combination of these glycols up to 50% by weight.

In some embodiments, the glycol is propylene glycol or glycerol and the fluid does not contain significant amounts of ethylene glycol or diethylene glycol. In one embodiment, the glycol is propylene glycol up to 50% by weight.

The fluid can be buffered with various buffers to control the pH variation should the sprinkler fluid be further diluted or contaminated with an acid or base. The buffer can comprise various alkali metal phosphates, borates and carbonates and/or glycines. These include combinations such as sodium phosphate, disodium phosphate, and trisodium phosphate, various borates, glycine, and combinations of sodium bicarbonate or potassium bicarbonate, sodium carbonate or potassium carbonate. The counter ions, e.g., sodium, potassium, lithium, calcium, and magnesium are not critical to the buffering and due to the presence of excess potassium may exchange with other cations. Calcium and magnesium salts are less preferred due to their bivalent nature and other considerations. Solubility of the buffers in concentrated potassium formate is a concern. Salts such as the carbonates are also expected to enhance the fire suppression ability of the fluid.

The presence of buffer in the fire sprinkler fluid has been observed to have a significant effect on the efficiency of the corrosion inhibiting agents. This is believed to be a combination of providing an optimum or nearly optimum pH for the corrosion inhibitors to do their job and supplying an alkalinity reserve that prevents the pH of the fluid from shifting downward, where the corrosion inhibitors might be less effective. The effect of pH on the corrosion inhibitors beyond sulfamic acid has not been fully explored. For the purpose of this application, we will define the amount of buffer as the amount of the buffer component that has a pH as a 1 wt. % solution in distilled water of above 10.0 or above 9.0 or above 8.0. Desirably, these buffers are present in amounts from about 0.1 to about 10 wt. %, more desirably from about 0.5 or 1 to about 3 or 5, and preferably from about 0.5 or 1 to about 3 wt. % based on the weight of the fluid. It is further defined that if basic versions of alkali metals are added to the fire sprinkler fluid, these may partially convert to other alkali metal phosphates, borates, and carbonates forms that would thereafter be considered buffers having a pH in the desired range. If this happens, then the converted materials would be counted in the total amount of buffers as a 1 wt. % solution in water.

It is desirable that the fire sprinkler fluid have a reserve alkalinity such that small amounts of acidic contaminants or acidic reaction products do not shift the pH of the fluid below a pH of 8. Desirably, the reserve alkalinity is measured according to ASTM D1121-98. Desirably, the reserve alkalinity of the fluid is from about 5 to about 40 mL of 0.100N HCl per 10 mL of sample to reach a pH of 5.5. More desirably, the reserve alkalinity of a less concentrated potassium formate solution (e.g., 10-30 wt. % alkali formate based on total fluid wt.) is from about 5 to about 20 mL of 0.100N HCl per a 10 mL sample and a more concentrated potassium formate (e.g., 30-65 wt. % alkali formate) would have a reserve alkalinity of from about 20 to about 40 mL of 0.100N HCl per 10 mL of sample. In some areas such as for FM approvals (Factory Mutual), it is required that the pH be 6.8 to 7.2. For this the same buffering principles described above can be applied.

The concentration of the formate salt in the fire sprinkler fluid only needs to be high enough to prevent freezing of the fluid. This is usually accomplished by determining the coldest temperature to which the fluid will be exposed and then forming a fluid that will remain unfrozen at a temperature at least 5° C. colder than the anticipated temperature.

Water is a preferred fire sprinkler fluid over aqueous mixtures with organic compounds due to its low viscosity and non-toxic nature as well as its higher heat capacity, heat transfer coefficient and fire corresponding fire suppression capability. However, water freezes at about 0° C. and the low carbon number carboxylate salt is necessary to allow the use of the water without freezing (to keep the water as a pumpable and sprayable liquid under conditions below 0° C. when used in a fire sprinkler system). Alternatively, the liquid may contain a glycol as well.

Desirably, the water is present in the low carbon number carboxylate salt solutions at concentrations of at least 20 weight percent based on the weight of the fire sprinkler fluid and more desirably from about 23 or 25 to about 95 or 98 weight percent of the fluid and preferably from about 50 to about 90 weight percent. In many glycol based fluids, a purified or distilled water is recommended to obtain good properties and longer fluid life. With said invention, tap water may be used to make up the fire sprinkler fluid and tap water may be used to dilute the fire sprinkler fluid.

Selected corrosion inhibitors which exhibit good solubility in high salt aqueous solutions are used in the low carbon number carboxylate salt based fluids. These corrosion inhibitors may be present in concentrations up to 4 weight percent and desirably above 0.001 weight percent or from about 0.1 weight percent up to 2 weight percent based on the weight of the fluid. Corrosion inhibitors include triazole inhibitors such as benzotriazole (preferred in combination), substituted benzotriazoles, tolyl triazole and its derivatives (e.g., Irgamet® 42), benzimidazole, a diazole such as dimercaptothiadiazole (preferred in combination); water-soluble aryl sulfonates, citric acid, sulfamic acid, inorganic nitrites, and mixtures of C₅ to C₈ monocarboxylic acid or alkali-, ammonium- or amino-salts of said acid, a C₂-C₈ dicarboxylic acid or alkali-, ammonium- or amino-salts of said acid (Irgacor® L 190). Vapor phase corrosion inhibitors can also be added to the fluid and would reduce corrosion on surfaces that are not always in contact with the fluid. A preferred vapor phase corrosion inhibitor would be tertiary amine, R₃N, where R contains 1 to 4 carbon atoms. Vapor phase corrosion inhibitors are generally desirable at concentrations up to 0.3 weight percent based on the weight of the fluid. Borates e.g., borax (optionally used as buffers) may also function as a corrosion inhibitor. Higher carboxylic acid such as 2-ethylhexanoic acid or dicarboxylic acids such as sebacic acid or their salts may act as corrosion inhibitors. Even some of the low carbon number carboxylic acid such a lactic or propionic acid, or low carbon number polyacid such as tartaric acid or citric acid or their salts may act as corrosion inhibitors as well as providing the other desired properties such as freezing point depression. Alternatively, low esters such a methyl, ethyl or hydroxyethyl esters or partial esters of the polyacids may function as corrosion inhibitors. The partial esters may be partially acid, or salt, such as the potassium, sodium or triethanolamine salt.

Biocides are also desirable components in the fire sprinkler fluid. The biocides prevent the growth of various plant and animal life that may be introduced from the water supply or which have been growing in the prior fluid. Desirably, the biocide is present at a concentration of less than 0.5 weight percent and more desirably less than 0.3 weight percent. Preferred biocides are various copper salts that can effectively control most plant and animal growth at less than 0.025 weight percent concentrations and more desirably less than 0.005 weight percent based on the weight of the fluid. The copper cation seems to be primarily associated with the biocide activity. With these copper salts, the actual copper concentration is less than 100 ppm and more desirably less than 25 ppm. Suitable copper salts include copper acetate, copper sulfate, and copper citrate. The copper salts may also assist in preventing certain types of corrosion. Glutaraldehyde can also be added to the fluid as a biocide. Borates also inhibit growth of bacteria, etc.

Desirably, both the corrosion inhibitors and the biocide are soluble at levels higher than that necessary for many applications so that the entire fire sprinkler fluid can be prepared as a concentrate. This provides an opportunity to deliver the effective concentrations of corrosion inhibitor and/or biocide upon dilution with water at the site of use to form a fire sprinkler fluid.

One can also include metal ion scavengers (chelating agents) such as ethylenediaminetetraacetic acid or its salt (EDTA). Desirable concentrations of chelating agents are up to 2 or 6 weight percent and more desirably from about 0.2 to about 6 weight percent based on the weight of the fluid.

Other optional additives might be included to increase the fire suppression ability of the fluid or reduce the fire potential of the organic materials in the fluids. These additives include aggressive antioxidants that function at mild temperatures as well as high temperature, such as phenothiazine, hydroquinone, 2-methylhydroquinone; gallic acid and esters such as methyl, ethyl, propyl or hydroxyethyl gallate; caffeic acid, esters or salts; butylated hydroxyanisole (BHA) or phenyl a-naphthylamine (PANA).

Mist suppressing agents such as water soluble polymers may reduce the potential for ignition of the droplets of fluids with high organic content. Such polymers may be polysaccharides, such as guar gum or xanthan gum or synthetic polymers such as poly AMPS® or salts thereof, copolymers of t-butylacrylamide and AMPS® or salts thereof. AMPS is a Trademark of The Lubrizol Corporation for the monomer 2-acrylamido-2-methylpropanesulfonic acid. Polyalkylene glycols such as polyethylene glycol may similarly function as mist suppressing agents as well as function as corrosion inhibitors or fire suppressing agents.

### EXAMPLES

Various combinations of at least potassium formate, optionally including potassium acetate were prepared in water and tested for heat transfer capacity, freezing points, corrosivity, and viscosity at reduced temperatures. The effect of various concentrations of the above components on the thermal conductivity, corrosion tendencies, freezing points, pH, and Brookfield viscosity at −40° C. were observed and recorded. The solutions compared favorably with propylene glycol solutions in terms of thermal conductivity. The solutions could be prepared with low corrosion tendencies towards copper and other metals. The solutions maintained low viscosities down to −40° C. Solutions containing up to 40% by weight or greater potassium formate were demonstrated to be compatible with chlorinated polyvinyl chloride (CPVC) in bent bar immersion tests and in tensile tests causing no loss in properties of the CPVC.

Similarly, combinations of potassium formate and propylene glycol in water were tested and found to have the desired physical and chemical properties at ambient and low temperatures. While propylene glycol alone at high concentrations in water was found to have combustibility and cause environmental stress cracking (ESC) of chlorinated polyvinylchloride (CPVC). In this context, environmental stress cracking is defined by an accelerated stress cracking test as a propensity of a CPVC bar, when in direct contact a solution of propylene glycol (or other fluid to be tested for its ability to initiate stress cracks) for a period of time has less mechanical strength than prior to its contact with the fluid. Sometimes, stress cracks are observable visually with slight magnification. ASTM F2331-04 for Determining Chemical Compatibility of Thread Sealants is often used to determine chemical compatibility of solvents or solutions with CPVC. This is usually accomplished by putting the solvent or solution in contact with a CPVC test bar, applying a weight in tension and monitoring the test bar for fracture in a period of time from 200 hours to 1000 hours. Typically, organic solutions cause stress cracking when the organic solution tends to swell a thin film of CPVC. Thus stress cracking is usually observed in organic media that swell CPVC to some extent. Potassium formate was found to mitigate the ESC of CPVC and combustibility of propylene glycol solutions in water. Propylene glycol at a concentration of 40% by weight propylene glycol in water while improved with respect to combustibility and ESC of CPVC compared to 60%, it was not low enough on freezing point for all locations for fire sprinkler fluids. Thus, at concentrations of propylene glycol at 40% or less, salts of low carbon number carboxylic acids, like potassium formate, will be most useful at achieving the desired properties for all locations and construction materials.

CPTherm® G-LT is a corrosion inhibited 55% by weight aqueous solution of potassium formate, available from CPI Engineering, Lubrizol in Midland, Mich. It was tested as a fire suppression fluid. A fluid was made from 40% CPTherm® and 60% by weight propylene glycol and was tested in a heptane fired combustibility test to examine nominally the high end of the useful propylene glycol range.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. It is to be understood that the upper and lower amount, range, and ratio limits set forth herein may be independently combined. While ranges are given for most of the elements of the invention independent of the ranges for other elements, it is anticipated that in more preferred embodiments of the invention, the elements of the invention are to be combined with the various (assorted) desired or preferred ranges for each element of the invention in various combinations. As used herein, the expression “consisting essentially of” permits the inclusion of substances that do not materially affect the basic and novel characteristics of the composition under consideration.

While the invention has been explained in relation to various embodiments, it is to be understood that various modifications thereof may become apparent to those skilled in the art upon reading this specification. Therefore, it is to be understood that the invention includes all such modifications that may fall within the scope of the appended claims.

What is claimed is:

1. A freezing point depressed aqueous fluid for a fire sprinkler system comprising in addition to water:
a) at least one low carbon number carboxylate salt at 10-50% by weight;
b) at least one glycol at 0-60% by weight; and
c) at least one corrosion inhibitor at 0.001-10% by weight, wherein said % by weight is based on the total weight of said freezing point depressed aqueous fluid.

2. A fluid according to claim 1, wherein said at least one low carbon number carboxylate salt comprises potassium or sodium formate or mixtures thereof and said fire sprinkler system further comprises one or more CPVC pipes or conduits.

3. A fluid according to claim 1, wherein the corrosion inhibitor comprises an alkali metal nitrite, amine, phosphonate, silicate, or carboxylic acid(s) or salt(s) thereof other than a) 2-mercaptobenzotriazole, aryl triazole, molybdate compound, sulfamic acid or salt thereof, ammonium bisulfate, or mixtures thereof in an amount from about 10 ppm to about 5% of the weight of the fluid.

4. A fluid according to claim 1, wherein said at least one glycol is present at a concentration of from 5 or 10% by weight based on said fluid and comprises propylene glycol, glycerine, ethylene glycol, diethylene glycol or mixtures thereof.

5. A fire sprinkler system containing the freezing point depressed aqueous fluid of claim 1.

6. A fire sprinkler system of claim 5 wherein the fire sprinkler system further comprises one or more CPVC pipes or conduits.

7. The use of a low carbon number carboxylate salt, such as potassium formate, to suppress the combustibility and/or heat release of propylene glycol containing freezing point depressed aqueous fluids applied as a spray by a fire sprinkler system.

8. The use of a low carbon number carboxylate salts, such as potassium formate, to mitigate the environmental stress cracking (ESC) potential of propylene glycol containing freezing point depressed aqueous fluids used in a fire sprinkler system comprising chlorinated polyvinylchloride (CPVC) pipe or conduit.
